(19) United States
(12) Patent Application Publication
(10) Pub. No.: US 2024/0425532 A1
(43) Pub. Date: Dec. 26, 2024

(54) STANNOUS ALKOXIDES AND RELATED METHODS

(71) Applicant: ENTEGRIS, INC., Billerica, MA (US)

(72) Inventor: David W. Ermert, Danbury, CT (US)

(21) Appl. No.: 18/739,060

(22) Filed: Jun. 10, 2024

Related U.S. Application Data
(60) Provisional application No. 63/522,337, filed on Jun. 21, 2023.

(51) Int. Cl. C07F 7/22

(52) U.S. Cl. CPC C07F 7/2224

(57) ABSTRACT

Methods for the synthesis of stannous alkoxides. Some embodiments of the method include contacting a stannous halide with a metal alkoxide to form a stannous alkoxide. Some embodiments of the method include contacting a tin amide compound with an alcohol compound to form a stannous alkoxide. Some embodiments of the method include contacting a stannous halide with at least 3 equivalents of a metal alkoxide to form a tin compound. Some embodiments of the method include contacting a stannous halide with an alcohol compound and a co-reactant base to form a stannous alkoxide.

### CROSS-REFERENCE TO RELATED APPLICATIONS

This application claims the benefit under 35 USC 119 of U.S. Provisional Patent Application No. 63/522,337, filed Jun. 21, 2023, the disclosure of which is hereby incorporated herein by reference in its entirety.

### FIELD

The present disclosure relates to stannous alkoxides and related methods.

### BACKGROUND

Some precursors are useful in the manufacture of microelectronic devices. The manufacture of such devices can involve use of deposition processes to form thin films, as well as extreme ultraviolet (EUV) lithography to form thin films.

### SUMMARY

Some embodiments of the present disclosure relate a method comprising: contacting a stannous halide with a metal alkoxide to form a stannous alkoxide, wherein the stannous halide comprises a compound of the formula:

SnX₂,
where:
X is independently a chloro, a bromo, a fluoro, or an iodo;
wherein the metal alkoxide comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, M is Li⁺, Na⁺, K⁺, Rb⁺, Cs⁺, Mg²⁺, Ca²⁺, Sr²⁺, Ba²⁺, or Zn²⁺.

In some embodiments, R is a C₁-C₃₀ alkyl.

In some embodiments, R is —C(CH₃)₃.

In some embodiments, R is —Si(CH₃)₃.

In some embodiments, the stannous halide is SnCl₂ and the metal alkoxide is KOC(CH₃)₃.

In some embodiments, the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide is at least 99.9%.

In some embodiments, the stannous alkoxide is [Sn(OC(CH₃)₃)₂]₂.

In some embodiments, a purity of the [Sn(OC(CH₃)₃)₂]₂ is at least 99.9%.

In some embodiments, the contacting does not form an impurity of the formula:

MSn(OR)₃,

[XSnOR]ₙ,
where:
M is an alkali metal cation, an alkaline earth metal cation, a transition metal cation, or a post-transition metal cation;
X is a halide;
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1 to 10.

In some embodiments, the impurity is KSn(OC(CH₃)₃)₃ or [ClSn(OtBu)]₂.

In some embodiments, the stannous alkoxide is formed in a single reaction step.

Some embodiments of the present disclosure relate a method comprising: contacting a tin amide compound with an alcohol compound to form a stannous alkoxide, wherein the tin amide compound comprises a compound of the formula:

[Sn(NR¹₂)₂]₂,
where:
R¹ is independently at least one of a hydrogen, an alkyl, a cycloalkyl, an aryl, or any combination thereof, or each R¹ is bonded to each other to form a C₃-C₂₀ N-heterocycle;
wherein the alcohol compound comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, R¹ is —CH₃.
In some embodiments, R is a C₁-C₃₀ alkyl.

In some embodiments, R is —C(CH₃)₃.

In some embodiments, R is —Si(CH₃)₃.

In some embodiments, the tin amide compound is [Sn(N(CH₃)₂]₂ and the alcohol compound is (CH₃)₃COH.

In some embodiments, the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide is at least 99.9%.

In some embodiments, the stannous alkoxide is [Sn(OC(CH₃)₃)₂]₂.

In some embodiments, a purity of the [Sn(OC(CH₃)₃)₂]₂ is at least 99.9%.

In some embodiments, the method further comprises recrystallizing the stannous alkoxide.

Some embodiments of the present disclosure relate a method comprising: contacting a stannous halide with at least 3 equivalents of a metal alkoxide to form a tin compound, wherein the stannous halide comprises a compound of the formula:

SnX₂,
where:
X is independently a chloro, a bromo, a fluoro, or an iodo;
wherein the metal alkoxide comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, the stannous halide is contacted with 3 to 3.15 equivalents of the metal alkoxide.

In some embodiments, M is Li⁺, Na⁺, K⁺, Rb⁺, Cs⁺, Mg²⁺, Mg²⁺, Sr²⁺, Ba²⁺, or Zn²⁺.

In some embodiments, R is a C₁-C₃₀ alkyl.

In some embodiments, R is —C(CH₃)₃.

In some embodiments, R is —Si(CH₃)₃.

In some embodiments, the stannous halide is SnCl₂ and the metal alkoxide is KOC(CH₃)₃.

In some embodiments, the tin compound comprises a compound of the formula:

MSn(OR)₃,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, a purity of the tin compound is at least 99.9%.

In some embodiments, the tin compound is KSn(OC(CH₃)₃)₃.

In some embodiments, a purity of the KSn(OC(CH₃)₃)₃ is at least 99.9%.

Some embodiments of the present disclosure relate a method comprising: contacting a stannous halide with an alcohol compound and a co-reactant base to form a stannous alkoxide, wherein the stannous halide comprises a compound of the formula:

SnX₂,
where:
X is independently a chloro, a bromo, a fluoro, or an iodo;
wherein the alcohol compound comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, R is a C₁-C₃₀ alkyl.

In some embodiments, R is —C(CH₃)₃.

In some embodiments, R is —Si(CH₃)₃.

In some embodiments, the co-reactant base comprises triethylamine.

In some embodiments, the stannous halide is SnCl₂, the alcohol compound is (CH₃)₃COH, and the co-reactant base is N(CH₂CH₃)₃.

In some embodiments, the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide is at least 99.9%.

In some embodiments, the stannous alkoxide is [Sn(OC(CH₃)₃)₂]₂.

In some embodiments, a purity of the [Sn(OC(CH₃)₃)₂]₂ is at least 99.9%.

Some embodiments of the present disclosure relate a composition comprising: a stannous alkoxide of the formula:

[Sn(OR)₂]ₙ,

where:

R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide is at least 99.9%.

In some embodiments, the stannous alkoxide is [Sn(OC(CH₃)₃)₂]₂.

In some embodiments, a purity of the [Sn(OC(CH₃)₃)₂]₂ is at least 99.9%.

Some embodiments of the present disclosure relate a composition comprising:
a tin compound comprises a compound of the formula:

MSn(OR)₃,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, a purity of the tin compound is at least 99.9%.

In some embodiments, the tin compound is KSn(OC(CH₃)₃)₃.

In some embodiments, a purity of the KSn(OC(CH₃)₃)₃ is at least 99.9%.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a method of forming a stannous alkoxide, according to some embodiments.

FIG. 2 depicts a reaction scheme of the method of FIG. 1, according to some embodiments.

FIG. 3 depicts a method of forming a stannous alkoxide, according to some embodiments.

FIG. 4 depicts a reaction scheme of the method of FIG. 3, according to some embodiments.

FIG. 5 depicts a method of forming a tin compound, according to some embodiments.

FIG. 6 depicts a reaction scheme of the method of FIG. 5, according to some embodiments.

FIG. 7 depicts a three-dimensional solid-state structure of KSn(OtBu)₃, according to some embodiments.

FIG. 8 depicts a method of forming a stannous alkoxide, according to some embodiments.

FIG. 9 depicts a reaction scheme of the method of FIG. 8, according to some embodiments.

FIG. 10 depicts a graph for the simultaneous thermogravimetric differential scanning calorimetry of [KSn(O^{t}Bu)₂]₂.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₈ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₈ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

As used herein, the term “amino” and/or “amine” refers to a functional group of formula —N(R^{a}R^{b}), wherein R^{a} and R^{b} are independently a hydrogen, an alkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylaminos may include, without limitation, one or more of the following: primary alkylaminos, such as, for example and without limitation, methylamino, ethylamino, n-propylamino, isopropylamino, n-butylamino, sec-butylamino, isobutylamino, t-butylamino, pentylamino, 2-aminopentane, 3-aminopentane, 1-amino-2-methylbutane, 2-amino-2-methylbutane, 3-amino-2-methylbutane, 4-amino-2-methylbutane, hexylamino, 5-amino-2-methylpentane, heptylamino, octylamino, nonylamino, decylamino, undecylamino, dodecylamino, tridecylamino, tetradecylamino, pentadecylamino, hexadecylamino, heptadecylamino, and octadecylamino; and secondary alkylaminos, such as, for example and without limitation, dimethylamino, diethylamino, dipropylamino, diisopropylamino, dibutylamino, diisobutylamino, di-sec-butylamino, di-t-butylamino, dipentylamino, dihexylamino, diheptylamino, dioctylamino, dinonylamino, didecylamino, methylethylamino, methylpropylamino, methylisopropylamino, methylbutylamino, methylisobutylamino, methyl-sec-butylamino, methyl-t-butylamino, methylamylamino, methylisoamylamino, ethylpropylamino, ethylisopropylamino, ethylbutylamino, ethylisobutylamino, ethyl-sec-butylamino, ethylamino, ethylisoamylamino, propylbutylamino, and propylisobutylamino. Unless otherwise provided herein, the terms “amine” and “amino” may be used interchangeably throughout this disclosure.

As used herein, the term “alkoxy” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “silyl” refers to a functional group of formula-Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula-Si(CH₃)₃.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl) (aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}R^{c}R^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “haloalkyl” refers to an alkyl as defined here, wherein at least one of the hydrogen atoms of the alkyl is replaced with a halide as defined herein. In some embodiments, the haloalkyl comprises a fluoroalkyl. In some embodiments, the fluoroalkyl comprises at least one of —CH₂CF₃, —CH(CF₃)₂, —CH₂F, —CH₂CH₂F, —CF₃, —CF₂CF₃, or any combination thereof.

As used herein, the term “halide” refers to a —Cl, —Br, —I, or —F.

As used herein, the term “metal cation” refers to at least one of a alkali metal cation, an alkaline earth metal cation, a transition metal cation, a post-transition metal cation, or any combination thereof. In some embodiments, the metal cation comprises a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallium cation, a lead cation, a bismuth cation, or a polonium cation. The charge(s) of the metal cations are known and, for simplicity, thus are not repeated here; however, it will be appreciated that the metal cations can have any known charge. For example, in some embodiments, the metal cation comprises Li⁺, Na⁺, K⁺, Rb⁺, Cs⁺, Mg²⁺, Mg²⁺, Sr²⁺, Ba²⁺, or Zn²⁺. In some embodiments, the metal cation is Sn(II) or Sn(IV).

Some embodiments relate to compositions useful in extreme-ultraviolet (EUV) lithography, among other applications, and related methods. The compositions disclosed herein include tin compounds. The tin compounds may be used to form tin-containing films (e.g., SnOₓ) useful in the fabrication of microelectronic devices, including semiconductor devices. For example, the precursor compositions may be stannous alkoxides ([Sn(OR)₂]ₙ) or tin compounds ([MSn(OR)₃]ₙ). The precursor compositions may be used as deposition precursors for generating tin-containing films. The tin-containing films may be used in dry resist applications or as reflective coatings for extreme-ultraviolet (EUV) lithography, among others. The precursor compositions may be formed according to the methods disclosed herein in high yield and high purity, while also minimizing the number of steps required to produce the precursor compositions.

The tin-containing films may also be formed according to the methods disclosed herein. That is, the tin-containing films disclosed herein may be formed by one or more deposition processes that utilize the precursor compositions. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

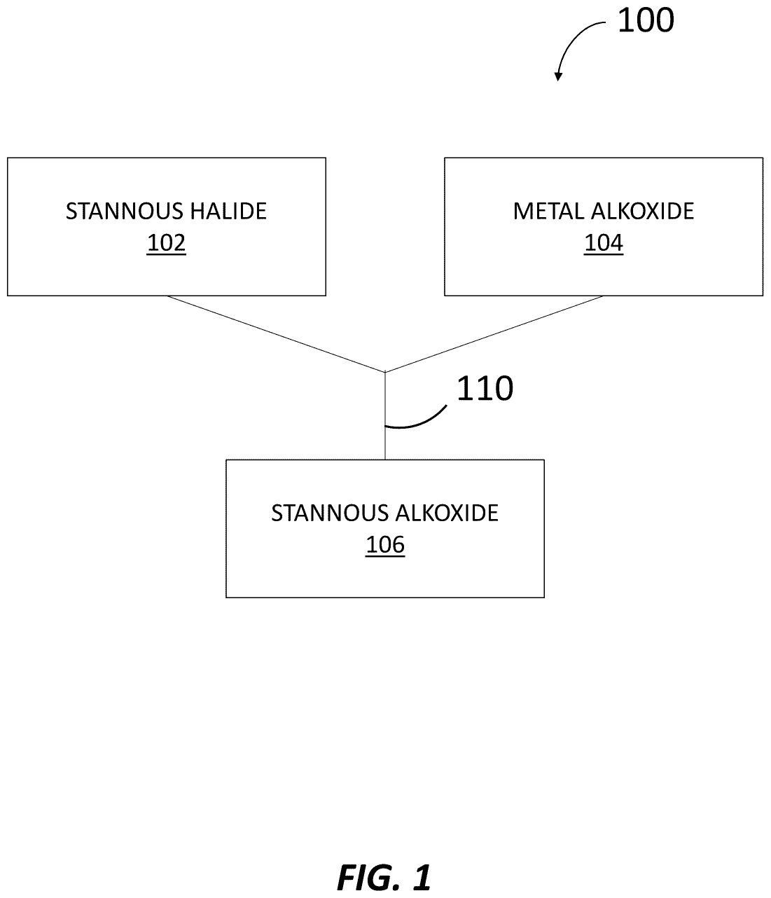

FIG. 1 is a flowchart of a method of forming a stannous alkoxide, according to some embodiments.

As shown in FIG. 1, the method 100 comprises a step 110 of contacting a stannous halide 102 with a metal alkoxide 104 to form a stannous alkoxide 106, wherein the stannous halide 102 comprises a compound of the formula:
SnX₂,
   where:
   X is independently a chloro, a bromo, a fluoro, or an iodo;
   wherein the metal alkoxide 104 comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, M is Li⁺, Na⁺, K⁺, Rb⁺, Cs⁺, Mg²⁺, Mg²⁺, Sr²⁺, Ba²⁺, or Zn²⁺.

In some embodiments, R is a C₁-C₃₀ alkyl.

In some embodiments, R is —C(CH₃)₃.

In some embodiments, R is —Si(CH₃)₃.

In some embodiments, M is an alkali metal cation and R is a C₁-C₄ alkyl. In some embodiments, M is an alkali metal cation and R is a silyl. In some embodiments, MOR is a metal isopropoxide.

In some embodiments, the stannous halide 102 is SnCl₂ and the metal alkoxide is KOC(CH₃)₃.

In some embodiments, the stannous alkoxide 106 comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide 106 is 85% to 99.9999%, or any range or subrange between 85% and 99.9999%. In some embodiments, the purity of the stannous alkoxide 106 is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the stannous alkoxide 106 is at least 99.9%, up to 99.9999%.

In some embodiments, the stannous alkoxide 106 is [Sn(OC(CH₃)₃)₂]₂. In some embodiments, a purity of the [Sn(OC(CH₃)₃)₂]₂ is at least 99.9%.

In some embodiments, the contacting does not form an impurity of the formula:

MSn(OR)₃,

[XSnOR]ₙ,
or any combination thereof, where:
M is an alkali metal cation, an alkaline earth metal cation, a transition metal cation, or a post-transition metal cation;
X is a halide;
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1 to 10.

In some embodiments, the impurity is KSn(OC(CH₃)₃)₃.

In some embodiments, the impurity is [ClSn(OtBu)]₂.

In some embodiments, the stannous alkoxide 106 is formed in a single reaction step.

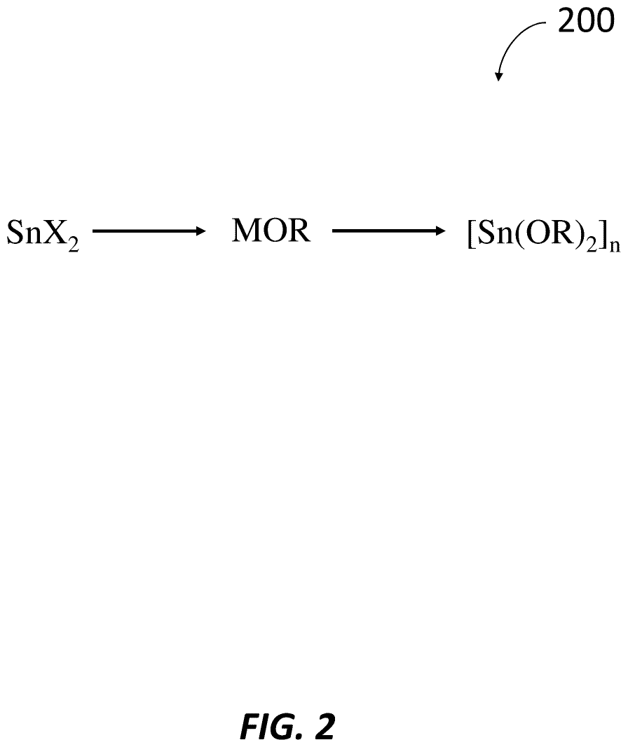

FIG. 2 depicts a reaction scheme 200 of the method of FIG. 1, according to some embodiments. As shown in FIG. 2, the stannous halide 102 (SnX₂) reacts with a metal alkoxide 104 (MOR) to form a stannous alkoxide 106 ([Sn(OR)₂]ₙ).

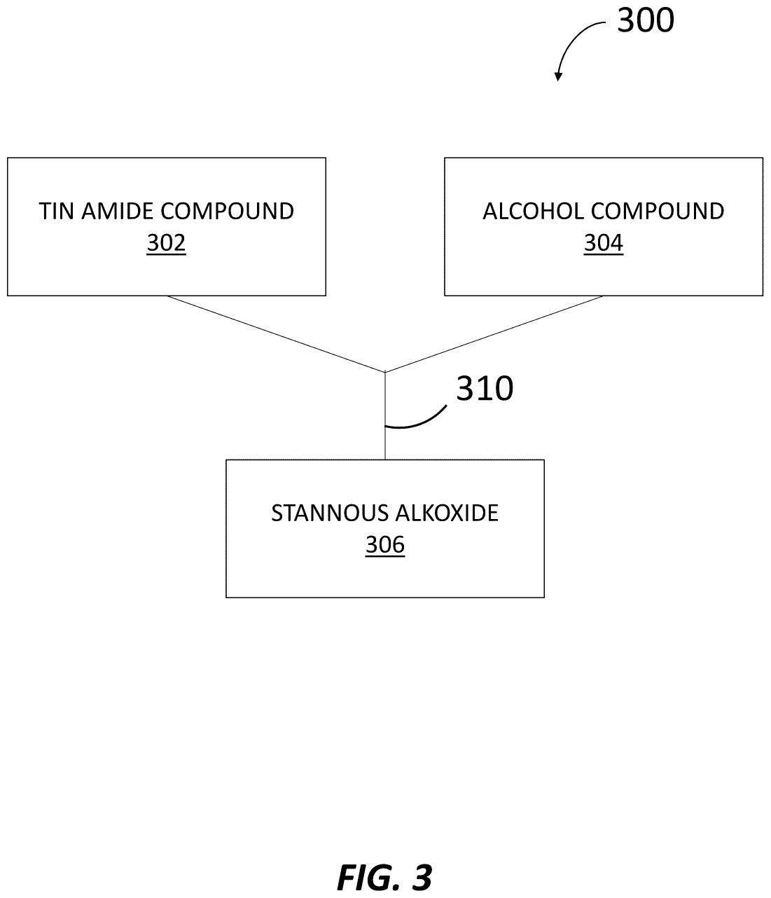

FIG. 3 is a flowchart of a method of forming a stannous alkoxide, according to some embodiments.

As shown in FIG. 3, the method 300 comprises a step 310 of contacting a tin amide compound 302 with an alcohol compound 304 to form a stannous alkoxide 306, wherein the tin amide compound 302 comprises a compound of the formula:

[Sn(NR₁₂)₂]₂,
where:
R¹ is independently at least one of a hydrogen, an alkyl, a cycloalkyl, an aryl, or any combination thereof, or each R¹ is bonded to each other to form a C₃-C₂₀ N-heterocycle;
wherein the alcohol compound 304 comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, each R¹ is the same. In some embodiments, each R¹ is different. In some embodiments, R¹ is —CH₃.

In some embodiments, R is a C₁-C₃₀ alkyl.

In some embodiments, R is —C(CH₃)₃.

In some embodiments, R is —Si(CH₃)₃.

In some embodiments, the tin amide compound 302 is [Sn(N(CH₃)₂]₂ and the alcohol compound 304 is (CH₃)₃COH.

In some embodiments, the stannous alkoxide 306 comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide 306 is 85% to 99.9999%, or any range or subrange between 85% and 99.9999%. In some embodiments, the purity of the stannous alkoxide 306 is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the stannous alkoxide 306 is at least 99.9%, up to 99.9999%.

In some embodiments, the stannous alkoxide 306 is [Sn(OC(CH₃)₃)₂]₂. In some embodiments, a purity of the [Sn(OC(CH₃)₃)₂]₂ is at least 99.9%.

In some embodiments, the method 300 further comprises recrystallizing the stannous alkoxide 306.

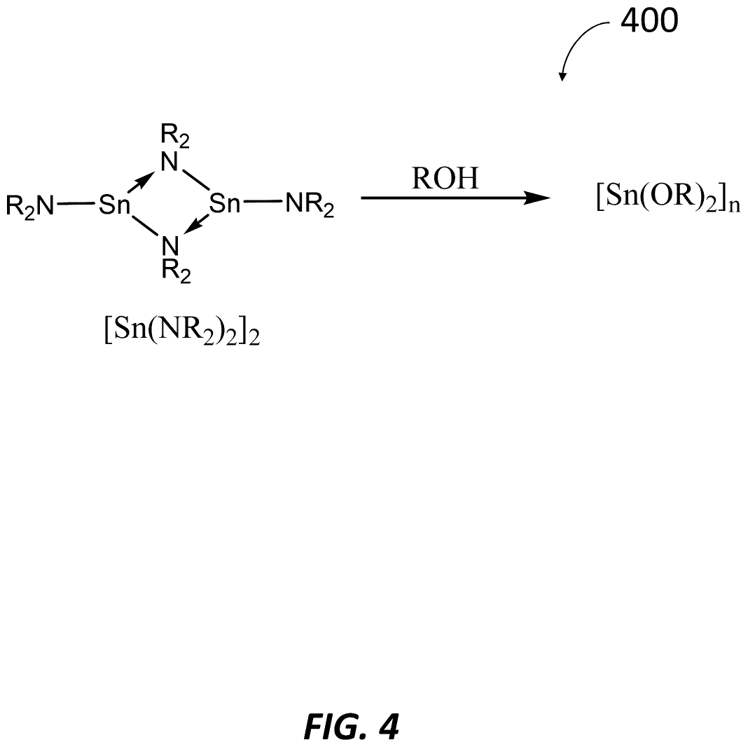

FIG. 4 depicts a reaction scheme 400 of the method of FIG. 3, according to some embodiments. As shown in FIG. 4, the tin amide compound 302 ([Sn(NR₂)₂]₂) reacts with a alcohol compound 304 (ROH) to form a stannous alkoxide 306 ([Sn(OR)₂]ₙ).

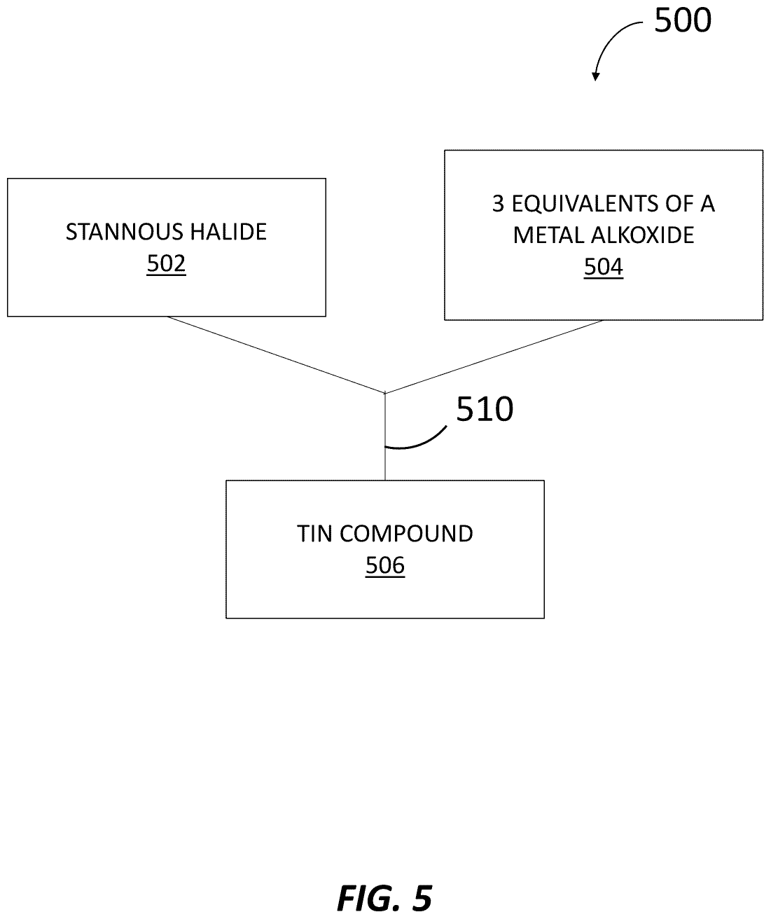

FIG. 5 is a flowchart of a method of forming a tin compound, according to some embodiments.

As shown in FIG. 5, the method 500 comprises a step 510 of contacting a stannous halide 502 with at least 3 equivalents of a metal alkoxide 504 to form a tin compound 506, wherein the stannous halide 502 comprises a compound of the formula:

SnX₂,
where:
X is independently a chloro, a bromo, a fluoro, or an iodo;
wherein the metal alkoxide 504 comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, the stannous halide 502 is contacted with 3 to 3.15 equivalents of the metal alkoxide 504.

In some embodiments, M is Li⁺, Na⁺, K⁺, Rb⁺, Cs⁺, Mg²⁺, Mg²⁺, Sr²⁺, Ba²⁺, or Zn²⁺.

In some embodiments, R is a C₁-C₃₀ alkyl.

In some embodiments, R is —C(CH₃)₃.

In some embodiments, R is —Si(CH₃)₃.

In some embodiments, M is an alkali metal cation and R is a C₁-C₄ alkyl. In some embodiments, M is an alkali metal cation and R is a silyl. In some embodiments, MOR is a metal isopropoxide.

In some embodiments, the stannous halide 502 is SnCl₂ and the metal alkoxide 504 is KOC(CH₃)₃.

In some embodiments, the tin compound 506 comprises a compound of the formula:

MSn(OR)₃,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, a purity of the tin compound 506 is 85% to 99.9999%, or any range or subrange between 85% and 99.9999%. In some embodiments, the purity of the tin compound 506 is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the tin compound 506 is at least 99.9%, up to 99.9999%.

In some embodiments, the tin compound 506 is KSn(OC(CH₃)₃)₃. In some embodiments, a purity of the KSn(OC(CH₃)₃)₃ is at least 99.9%.

In some embodiments, the tin compound 506 is [KSn(O^{t}Bu)₂]₂ or KSn(O^{t}Bu)₃.

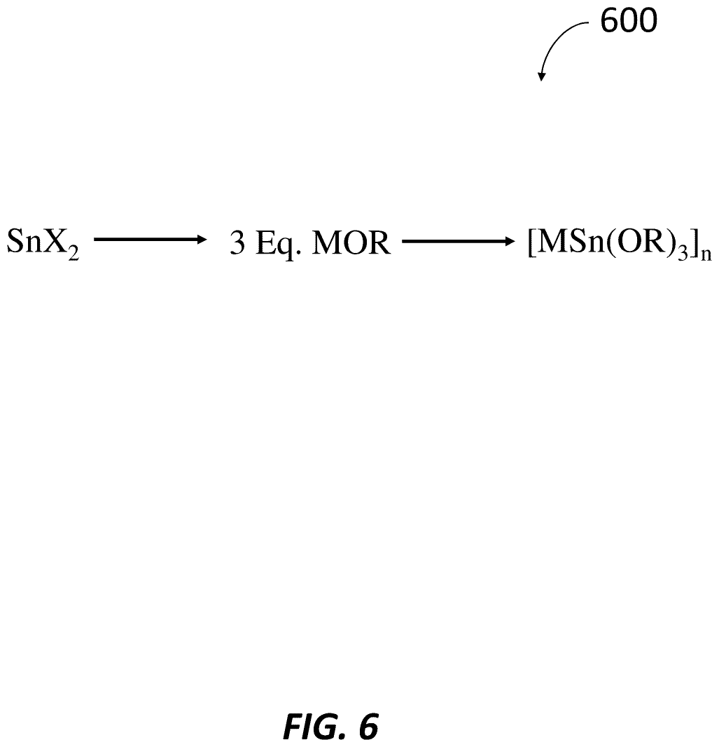

FIG. 6 depicts a reaction scheme 600 of the method of FIG. 5, according to some embodiments. As shown in FIG. 6, the stannous halide 502 (SnX₂) reacts with three equivalents of a metal alkoxide 504 (MOR) to form a tin compound 506 ([Sn(OR)₃]ₙ).

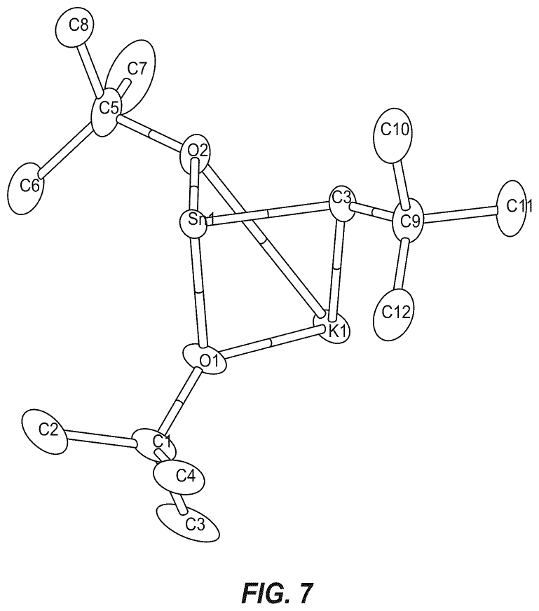

FIG. 7 depicts a three-dimensional solid-state structure of KSn(O^{t}Bu)₃, according to some embodiments.

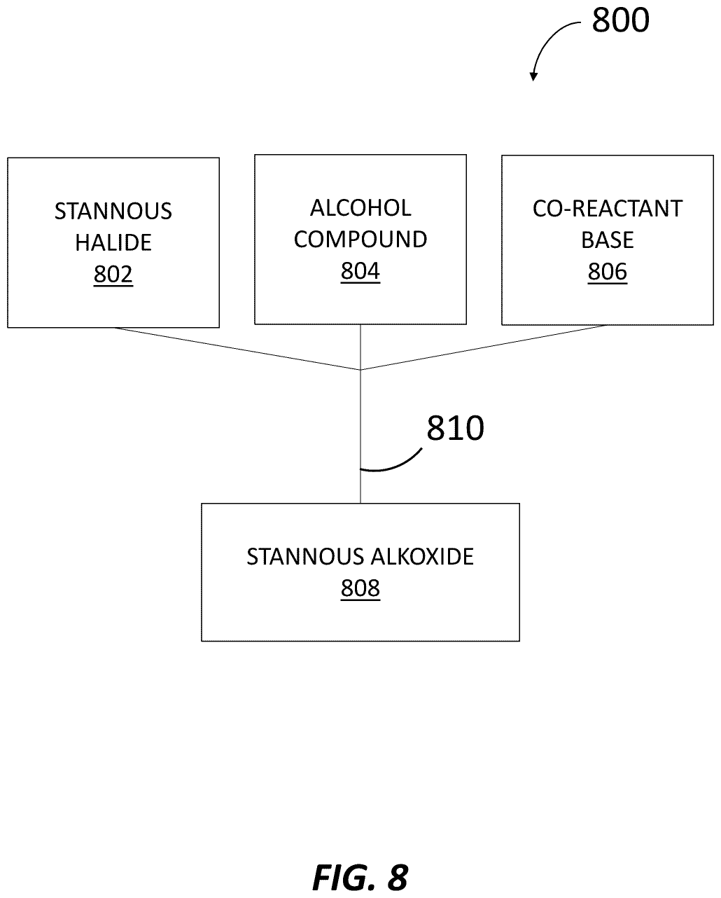

FIG. 8 is a flowchart of a method of forming a stannous alkoxide, according to some embodiments.

As shown in FIG. 8, the method 800 comprises a step 810 of contacting a stannous halide 802 with an alcohol compound 804 and a co-reactant base 806 to form a stannous alkoxide 808, wherein the stannous halide 802 comprises a compound of the formula:

SnX₂,
where:
X is independently a chloro, a bromo, a fluoro, or an iodo;
wherein the alcohol compound 804 comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, R is a C₁-C₃₀ alkyl.

In some embodiments, R is —C(CH₃)₃.

In some embodiments, R is —Si(CH₃)₃.

In some embodiments, the co-reactant base 806 comprises triethylamine.

In some embodiments, the stannous halide 802 is SnCl₂, the alcohol compound 804 is (CH₃)₃COH, and the co-reactant base 806 is N (CH₂CH₃)₃.

In some embodiments, the stannous alkoxide 808 comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide 808 is 85% to 99.9999%, or any range or subrange between 85% and 99.9999%. In some embodiments, the purity of the stannous alkoxide 808 is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the stannous alkoxide 808 is at least 99.9%, up to 99.9999%.

In some embodiments, the stannous alkoxide 808 is [Sn(OC(CH₃)₃)₂]₂. In some embodiments, a purity of the [Sn(OC(CH₃)₃)₂]₂ is at least 99.9%.

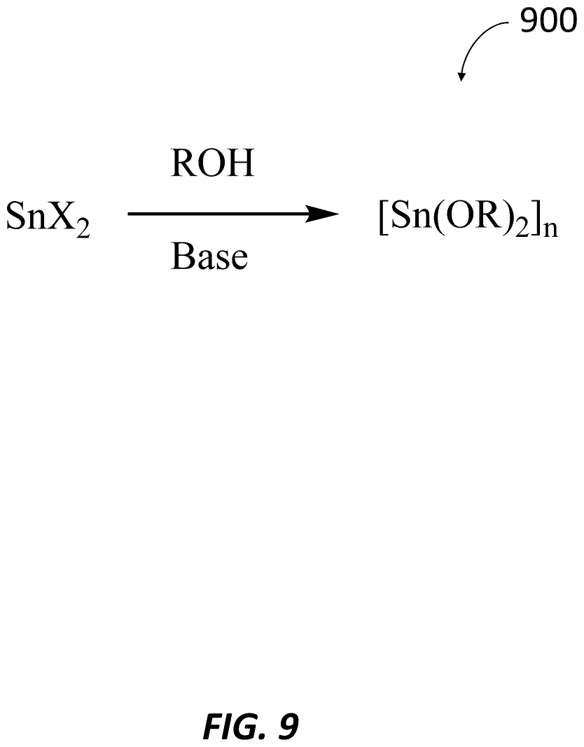

FIG. 9 depicts a reaction scheme 900 of the method of FIG. 8, according to some embodiments. As shown in FIG. 9, the stannous halide 802 (SnX₂) reacts with a alcohol compound 804 (ROH) and a co-reactant base 806 (Base) to form a stannous alkoxide 808 ([Sn(OR)₂]ₙ).

Some embodiments of the present disclosure relate a composition comprising:
a stannous alkoxide of the formula:

[Sn(OR)₂]n,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

In some embodiments, a purity of the stannous alkoxide is 85% to 99.9999%, or any range or subrange between 85% and 99.9999%. In some embodiments, the purity of the stannous alkoxide is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the stannous alkoxide is at least 99.9%, up to 99.9999%.

In some embodiments, the stannous alkoxide 306 is [Sn(OC(CH₃)₃)₂]₂. In some embodiments, a purity of the [Sn(OC(CH₃)₃)₂]₂ is at least 99.9%.

Some embodiments of the present disclosure relate a composition comprising:
a tin compound comprises a compound of the formula:

MSn(OR)₃,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, a purity of the tin compound is 85% to 99.9999%, or any range or subrange between 85% and 99.9999%. In some embodiments, the purity of the tin compound is 90% to 99.9999%, 95% to 99.9999%, 96% to 99.9999%, 97% to 99.9999%, 98% to 99.9999%, 99% to 99.9999%, 99% to 99.999%, 99% to 99.99%, or 99% to 99.9%. In some embodiments, the purity of the tin compound is at least 99.9%, up to 99.9999%. In some embodiments, the purity is established by Nuclear Magnetic Resonance (NMR). In some embodiments, the purity is established by molecular assay.

In some embodiments, the tin compound is KSn(OC(CH₃)₃)₃. In some embodiments, a purity of the KSn(OC(CH₃)₃)₃ is at least 99.9%.

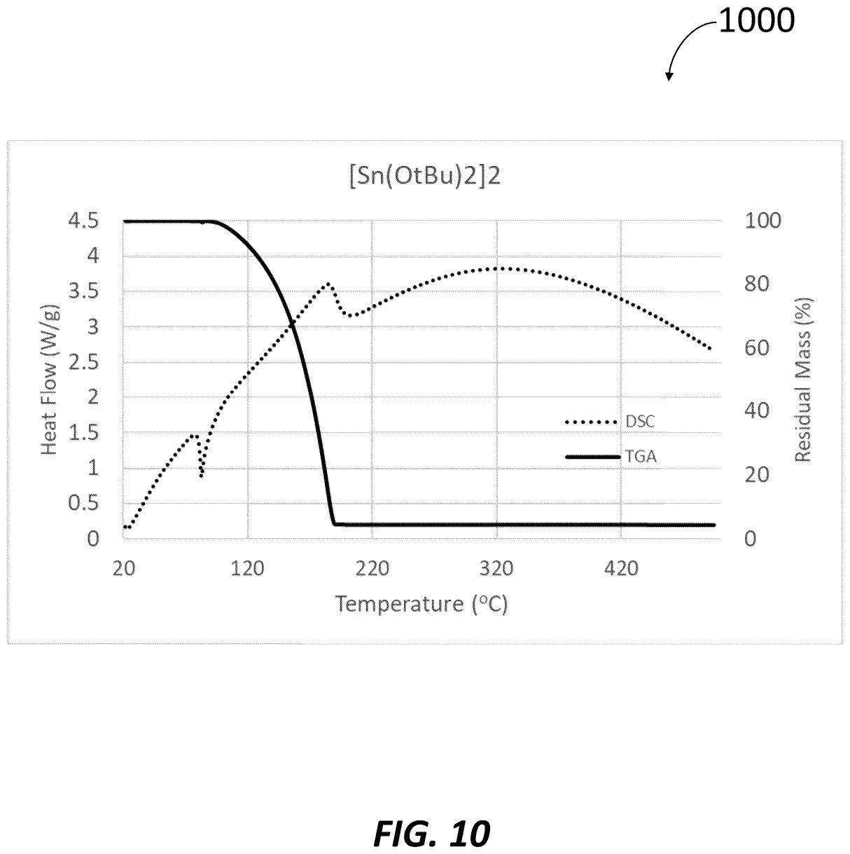

FIG. 10 depicts a graph for the simultaneous thermogravimetric differential scanning calorimetry of [KSn(O^{t}Bu)₂]₂.

### Example 1

### Synthesis of [Sn(O^{t}Bu)₂]₂ from SnCl₂

In a nitrogen-filled glovebox, SnCl₂ (3.0 g, 15.6 mmol) was loaded into a 40 mL amber vial equipped with a magnetic stir bar and dissolved in 15 mL of THF. Separately, KO^{t}Bu (3.51 g, 31.3 mmol) was dissolved in 20 mL of THF and added to the SnCl₂ solution with stirring over the course of five minutes, resulting in a slight exotherm and the appearance of a voluminous white precipitate. The resulting white mixture was stirred at room temperature for 16 hours, at which point the solvent was removed under reduced pressure to yield a tacky white solid. The product was extracted with 25 mL of hexanes at 50° C., filtered through a 0.2 μm syringe filter, and the colorless filtrate dried under reduced pressure to yield [KSn(O^{t}Bu)₂]₂ as a free-flowing white solid. The product was purified by crystallizing from a concentrated hexanes solution at −35° C., decanting the mother liquor, and drying the colorless crystals to yield 1.86 g (44.2% yield) of [KSn(O^{t}Bu)₂]₂ in >99.9% purity by ¹H-, and ¹¹⁹Sn-NMR. Melting Point: 83.28° C. (DSC). ¹H {¹³C}-NMR (400 MHz, C₆D₆, 298K): 1.40 (s, 36H) ppm; ¹³C {¹H}-NMR (100 MHZ, C⁶D⁶, 298K): 34.13, 35.16 (b) ppm; ¹¹⁹Sn {¹H}-NMR (149 MHZ, C⁶D⁶, 298K): −91.1 ppm. ¹H {¹³C}-NMR (400 MHZ, CDCl₃, 298K): 1.39 (s, 36H) ppm; ¹³C {¹H}-NMR (100 MHZ, CDCl₃, 298K): 33.76, 35.52, 71.58, 75.87 ppm; ¹¹⁹Sn {¹H}-NMR (149 MHZ, CDCl₃, 298K): −100.94 ppm.

### Example 2

### Synthesis of [KSn(O^{t}Bu)₂]₂ from [Sn(N(CH₃)₂)₂]₂

In a nitrogen-filled glovebox, [Sn(N(CH₃)₂)₂]₂ (5.0 g, 12.0 mmol) was placed in 100 mL Schlenk flask equipped with a magnetic stir bar and dissolved in 50 mL of hexanes. Tert-butanol (3.55 g, 48.0 mmol) was added to the stirred solution over the course of 15 minutes, resulting in an exotherm. Upon complete addition, the reaction was stirred for 12 hours at room temperature, at which point, the volatiles were removed under reduced pressure to yield crude [Sn(O^{t}Bu)₂]₂ as a white solid. The solid was recrystallized from a saturated hexanes solution at −35° C., isolated by decanting the supernatant, and dried under reduced pressure to yield [Sn(OtBu)₂]₂ as a free-flowing microcrystalline solid in >99.9% purity by NMR. Mass: 2.59 g (40.5% yield). Melting Point: 82.83° C. (DSC). ¹H-, ¹³C-, and ¹¹⁹Sn-NMR data collected on a C₆D₆ solution of the product were consistent with the aforementioned method of using SnCl₂ and KOtBu and those reported in the literature.

### Example 3

### Synthesis of [KSn(O^{t}Bu)₂]₂ from SnCl₂ and ^{t}BuOH/NE₁₃

In a nitrogen-filled glovebox, SnCl₂ (3 g, 15.6 mmol) was placed a 40 mL amber vial equipped with a magnetic stir bar and dissolved in 20 mL of THF. NEt₃ (4.72 g, 46.7 mmol) was added to the SnCl₂ solution. A t-butanol (2.42 g, 32.7 mmol) solution was made in 10 mL of THF and added to the SnCl₂ solution over the course of 5 minutes. The resulting slightly cloudy solution was stirred for 12 hours at room temperature, at which point, the volatiles were removed under reduced pressure to yield a white solid. The product was extracted with PhMe (20 mL) @ 50° C., the resulting white mixture filtered through a 0.2 μm syringe filter, and the colorless solution dried under reduced pressure to yield 1.33 g (32%) of a white solid. ¹H-, ¹³C-, and ¹¹⁹Sn-NMR collected on a CDCl₃ solution of the product are consistent with isolation of the target molecule as per the previous examples and literature references.

### Example 4

### Synthesis of KSn(O^{t}Bu)₃

In a nitrogen-filled glovebox, SnCl₂ (3.0 g, 15.6 mmol) was loaded into a 40 mL amber vial equipped with a magnetic stir bar and dissolved in 35 mL of THF. KO^{t}Bu (5.25 g, 15.63 mmol) was added directly to the SnCl₂ solution with stirring over the course 15 minutes, resulting in an exotherm and the generation of a white precipitate. The white mixture was stirred at room temperature overnight, whereby, the reaction was filtered through a 0.2 μm syringe filter and the colorless filtrate dried under reduced pressure to yield the product as a white solid, mass: 3.98 g (67.7% yield), in >99.9% purity by ¹H-, and ¹¹⁹Sn-NMR. X-ray quality crystals were grown from a saturated hexanes solution at −35° C. ¹H {¹³C}-NMR (400 MHZ, C₆D₆, 298K): 1.42 (s, 27H) ppm; ¹³C {¹H}-NMR (100 MHZ, C₆D₆, 298K): 35.92, 69.93 ppm; ¹¹⁹Sn {¹H}-NMR (149 MHZ, C₆D₆, 298K): −174.68 ppm. ¹H {¹³C}-NMR (400 MHZ, d₈-THF, 298K): 1.22 (s, 27H) ppm; ¹³C {¹H}-NMR (100 MHZ, d₈-THF, 298K): 35.72, 69.51 ppm; ¹¹⁹Sn {¹H}-NMR (149 MHZ, d₈-THF, 298K): −180.26 ppm. See Table 1 for crystal data and structure refinement for KSn(O^{t}Bu)₃.

### Example 5

### Synthesis of [ClSn(O^{t}Bu)]₂

In a nitrogen-filled glovebox, [KSn(O^{t}Bu)₂]₂ (2.0 g, 3.76 mmol) was loaded into a vial equipped with a magnetic stir bar and dissolved in THF (10 mL). SnCl₂ (1.44 g, 7.52 mmol) was added to the solution with stirring over the course of one minute to produce a cloudy white mixture. Upon complete addition, the reaction mixture was stirred at room temperature for 12 hours, at which point, the volatiles were removed under reduced pressure to yield a brilliant white microcrystalline solid. ¹H {¹³C}-NMR (400 MHZ, CDCl₃, 298K): 1.48 (s, 18H) ppm; ¹³C {¹H}-NMR (100 MHZ, CDCl₃, 298K): 33.19, 78.50 ppm; ¹¹⁹Sn {¹H}-NMR (149 MHZ, CDCl₃, 298K): −87.83 ppm.

TABLE 1
Crystal data and structure refinement for KSn(O^{t}Bu)₃

| Empirical formula | C12 H27 K O3 Sn | |
|---|---|---|
| Molecular formula | C12 H27 K O3 Sn | |
| Formula weight | 377.12 | |
| Temperature | 100.00 K | |
| Wavelength | 0.71073 Å | |
| Crystal system | Orthorhombic | |
| Space group | P2₁2₁2₁ | |
| Unit cell dimensions | a = 8.7960(11) Å | α = 90°. |
| | b = 10.4276(13) Å | β = 90°. |
| | c = 18.924(2) Å | γ = 90°. |

| | |
|---|---|
| Volume | 1735.7(4) Å3 |
| Z | 4 |
| Density (calculated) | 1.443 Mg/m³ |
| Absorption coefficient | 1.708 mm⁻¹ |
| F(000) | 768 |
| Crystal size | 0.2 × 0.02 × 0.02 mm³ |
| Crystal color, habit | colorless needle |
| Theta range for data collection | 2.553 to 26.370°. |
| Index ranges | −10 <= h <= 10, −13 <= k <= 13, |
| | −23 <= l <= 23 |
| Reflections collected | 30164 |
| Independent reflections | 3532 [R(int) = 0.0450] |
| Completeness to theta = 25.242° | 99.9% |
| Absorption correction | Semi-empirical from equivalents |
| Max. and min. transmission | 0.4910 and 0.4089 |
| Refinement method | Full-matrix least-squares on F2 |
| Data/restraints/parameters | 3532/0/194 |
| Goodness-of-fit on F2 | 1.082 |
| Final R indices [I > 2sigma(I)] | R1 = 0.0173, wR2 = 0.0348 |
| R indices (all data) | R1 = 0.0190, wR2 = 0.0354 |
| Absolute structure parameter | 0.004(13) |
| Largest diff. peak and hole | 0.356 and −0.357 e.Å−3 |

### ASPECTS

Various Aspects are described below. It is to be understood that any one or more of the features recited in the following Aspect(s) can be combined with any one or more other Aspect(s).

Aspect 1. A method comprising: contacting a stannous halide with a metal alkoxide to form a stannous alkoxide,
wherein the stannous halide comprises a compound of the formula:

SnX₂,
where:
X is independently a chloro, a bromo, a fluoro, or an iodo;
wherein the metal alkoxide comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Aspect 2. The method according to Aspect 1, wherein M is Li⁺, Na⁺, K⁺, Rb⁺, Cs⁺, Mg²⁺, Mg²⁺, Sr²⁺, Ba²⁺, or Zn²⁺.

Aspect 3. The method according to any one of Aspects 1-2, wherein R is —C(CH₃)₃.

Aspect 4. The method according to any one of Aspects 1-3, wherein R is —Si(CH₃)₃.

Aspect 5. The method according to any one of Aspects 1-4, wherein the stannous halide is SnCl₂ and the metal alkoxide is KOC(CH₃)₃.

Aspect 6. The method according to any one of Aspects 1-5, wherein the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

Aspect 7. The method according to any one of Aspects 1-6, wherein In some embodiments, a purity of the stannous alkoxide is at least 99.9%.

Aspect 8. The method according to any one of Aspects 1-7, wherein In some embodiments, the stannous alkoxide is [Sn(OC(CH₃)₃)₂]₂.

Aspect 9. The method according to any one of Aspects 1-8, wherein In some embodiments, a purity of the [Sn(OC(CH₃)₃)₂]₂ is at least 99.9%.

Aspect 10. The method according to any one of Aspects 1-9, wherein the contacting does not form an impurity of the formula:

MSn(OR)₃,

[XSnOR]ₙ,
or any combination thereof, where:
M is an alkali metal cation, an alkaline earth metal cation, a transition metal cation, or a post-transition metal cation;
X is a halide;
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
N is 1 to 10.

Aspect 11. The method according to any one of Aspects 1-10, wherein the impurity is KSn(OC(CH₃)₃)₃ or [ClSn(O^{t}Bu)]₂.

Aspect 12. The method according to any one of Aspects 1-11, wherein In some embodiments, the stannous alkoxide is formed in a single reaction step.

Aspect 13. A method comprising: contacting a tin amide compound with an alcohol compound to form a stannous alkoxide, wherein the tin amide compound comprises a compound of the formula:

[Sn(NR₁₂)₂]₂,
where:
R¹ is independently at least one of a hydrogen, an alkyl, a cycloalkyl, an aryl, or any combination thereof, or each R¹ is bonded to each other to form a C₃-C₂₀ N-heterocycle;
wherein the alcohol compound comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Aspect 14. The method according to Aspect 13, R¹ is —CH₃.

Aspect 15. The method according to any one of Aspects 13-14, wherein R is —C(CH₃)₃.

Aspect 16. The method according to any one of Aspects 13-15, wherein R is-Si(CH₃)₃.

Aspect 17. The method according to any one of Aspects 13-16, wherein the tin amide compound is [Sn(N(CH₃)₂]₂ and the alcohol compound is (CH₃)₃COH.

Aspect 18. The method according to any one of Aspects 13-17, wherein the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

Aspect 19. The method according to any one of Aspects 13-18, wherein a purity of the stannous alkoxide is at least 99.9%.

Aspect 20. The method according to any one of Aspects 13-19, wherein the stannous alkoxide is [Sn(OC(CH₃)₃)₂]₂.

Aspect 21. The method according to any one of Aspects 13-20, wherein a purity of the [Sn(OC(CH₃)₃)₂]₂ is at least 99.9%.

Aspect 22. The method according to any one of Aspects 13-21, wherein the method further comprises recrystallizing the stannous alkoxide.

Aspect 23. A method comprising: contacting a stannous halide with at least 3 equivalents of a metal alkoxide to form a tin compound,
wherein the stannous halide comprises a compound of the formula:

SnX₂,
where:
X is independently a chloro, a bromo, a fluoro, or an iodo;
wherein the metal alkoxide comprises a compound of the formula:

MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Aspect 24. The method according to Aspect 23, wherein the stannous halide is contacted with 3 to 3.15 equivalents of the metal alkoxide.

Aspect 25. The method according to any one of Aspects 23-24, wherein M is Li⁺, Na⁺, K⁺, Rb⁺, Cs⁺, Mg²⁺, Mg²⁺, Sr²⁺, Ba²⁺, or Zn²⁺.

Aspect 26. The method according to any one of Aspects 23-25, wherein R is —C(CH₃)₃.

Aspect 27. The method according to any one of Aspects 23-26, wherein R is-Si(CH₃)₃.

Aspect 28. The method according to any one of Aspects 23-27, wherein the stannous halide is SnCl₂ and the metal alkoxide is KOC(CH₃)₃.

Aspect 29. The method according to any one of Aspects 23-28, wherein the tin compound comprises a compound of the formula:

MSn(OR)₃,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Aspect 30. The method according to any one of Aspects 23-29, wherein a purity of the tin compound is at least 99.9%.

Aspect 31. The method according to any one of Aspects 23-30, wherein the tin compound is KSn(OC(CH₃)₃)₃.

Aspect 32. The method according to any one of Aspects 23-31, wherein a purity of the KSn(OC(CH₃)₃)₃ is at least 99.9%.

Aspect 33. A method comprising: contacting a stannous halide with an alcohol compound and a co-reactant base to form a stannous alkoxide, wherein the stannous halide comprises a compound of the formula:

SnX₂,
where:
X is independently a chloro, a bromo, a fluoro, or an iodo;
wherein the alcohol compound comprises a compound of the formula:

ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Aspect 34. The method according to Aspect 33, wherein R is —C(CH₃)₃.

Aspect 35. The method according to any one of Aspects 33-34, wherein R is —Si(CH₃)₃.

Aspect 36. The method according to any one of Aspects 33-35, wherein the co-reactant base comprises triethylamine.

Aspect 37. The method according to any one of Aspects 33-36, wherein the stannous halide is SnCl₂, the alcohol compound is (CH₃)₃COH, and the co-reactant base is N(CH₂CH₃)₃.

Aspect 38. The method according to any one of Aspects 33-37, wherein the stannous alkoxide comprises a compound of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

Aspect 39. The method according to any one of Aspects 33-38, wherein a purity of the stannous alkoxide is at least 99.9%.

Aspect 40. The method according to any one of Aspects 33-39, wherein the stannous alkoxide is [Sn(OC(CH₃)₃)₂]₂.

Aspect 41. The method according to any one of Aspects 33-40, wherein a purity of the [Sn(OC(CH₃)₃)₂]₂ is at least 99.9%.

Aspect 42. A composition comprising:

a stannous alkoxide of the formula:

[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

Aspect 43. The composition according to Aspect 42, wherein a purity of the stannous alkoxide is at least 99.9%.

Aspect 44. The composition according to any one of Aspects 42-43, wherein the stannous alkoxide is [Sn(OC(CH₃)₃)₂]₂.

Aspect 45. The composition according to Aspect 44, wherein a purity of the [Sn(OC(CH₃)₃)₂]₂ is at least 99.9%.

Aspect 46. A composition comprising:
a tin compound comprises a compound of the formula:

MSn(OR)₃,

[XSnOR]ₙ,
or any combination thereof, where:
M is an alkali metal cation, an alkaline earth metal cation, a transition metal cation, or a post-transition metal cation;
X is a halide;
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1 to 10.

Aspect 47. The method according to Aspect 46, wherein a purity of the tin compound is at least 99.9%.

Aspect 48. The method according to any one of Aspects 46-47, wherein the tin compound is KSn(OC(CH₃)₃)₃.

Aspect 49. The method according to Aspect 48, wherein a purity of the KSn(OC(CH₃)₃)₃ is at least 99.9%.

Aspect 50. The method according to any one of Aspects 1-49, wherein R is a C₁-C₃₀ alkyl.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
contacting a stannous halide with a metal alkoxide to form a stannous alkoxide, wherein the stannous halide comprises a compound of the formula:
SnX₂,
where:
X is independently a chloro, a bromo, a fluoro, or an iodo;
wherein the metal alkoxide comprises a compound of the formula:
MOR,
where:
M is an alkali metal cation, an alkaline earth metal cation, a transition metal cation, or a post-transition metal cation; and
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

2. The method of claim 1, wherein M is Li⁺, Na⁺, K⁺, Rb⁺, Cs⁺, Mg²⁺, Mg²⁺, Sr²⁺, Ba²⁺, or Zn²⁺.

3. The method of claim 1, wherein R is a C₁-C₃₀ alkyl.

4. The method of claim 1, wherein R is —C(CH₃)₃.

5. The method of claim 1, wherein the stannous halide is SnCl₂ and the metal alkoxide is KOC(CH₃)₃.

6. The method of claim 1, wherein the stannous alkoxide comprises a compound of the formula:
[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

7. The method of claim 1, wherein a purity of the stannous alkoxide is at least 99.9%.

8. The method of claim 1, wherein the stannous alkoxide is [Sn(OC(CH₃)₃)₂]₂.

9. The method of claim 8, wherein a purity of the [Sn(OC(CH₃)₃)₂]₂ is at least 99.9%.

10. The method of claim 1, wherein the contacting does not form an impurity of the formula:
MSn(OR)₃,
[XSnOR]ₙ,
or any combination thereof, where:
M is an alkali metal cation, an alkaline earth metal cation, a transition metal cation, or a post-transition metal cation;
X is a halide;
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1 to 10.

11. The method of claim 10, wherein the impurity is KSn(OC(CH₃)₃)₃ or [ClSn(O^{t}Bu)]₂.

12. A method comprising:
contacting a tin amide compound with an alcohol compound to form a stannous alkoxide,
wherein the tin amide compound comprises a compound of the formula:
[Sn(NR¹₂)₂]₂,
where:
R¹ is independently at least one of a hydrogen, an alkyl, a cycloalkyl, an aryl, or any combination thereof, or each R¹ is bonded to each other to form a C₃-C₂₀ N-heterocycle;
wherein the alcohol compound comprises a compound of the formula:
ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

13. The method of claim 12, wherein R¹ is —CH₃.

14. The method of claim 12, wherein R is —C(CH₃)₃.

15. The method of claim 12, wherein the tin amide compound is [Sn(N(CH₃)₂]₂ and the alcohol compound is (CH₃)₃COH.

16. The method of claim 12, wherein the stannous alkoxide comprises a compound of the formula:
[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

17. The method of claim 12, wherein a purity of the stannous alkoxide is at least 99.9%.

18. The method of claim 12, wherein the stannous alkoxide is [Sn(OC(CH₃)₃)₂]₂.

19. The method of claim 18, wherein a purity of the [Sn(OC(CH₃)₃)₂]₂ is at least 99.9%.

20. The method of claim 18, further comprising recrystallizing the stannous alkoxide.

21. A method comprising:
contacting a stannous halide with an alcohol compound and a co-reactant base to form a stannous alkoxide,
wherein the stannous halide comprises a compound of the formula:
SnX₂,
where:
X is independently a chloro, a bromo, a fluoro, or an iodo;
wherein the alcohol compound comprises a compound of the formula:
ROH,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

22. The method of claim 21, wherein R is a C₁-C₃₀ alkyl.

23. The method of claim 21, wherein R is —C(CH₃)₃.

24. The method of claim 21, wherein the stannous halide is SnCl₂, the alcohol compound is (CH₃)₃COH, and the co-reactant base is N(CH₂CH₃)₃.

25. The method of claim 21, wherein the stannous alkoxide comprises a compound of the formula:
[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

26. The method of claim 21, wherein a purity of the stannous alkoxide is at least 99.9%.

27. The method of claim 21, wherein the stannous alkoxide is [Sn(OC(CH₃)₃)₂]₂.

28. The method of claim 27, wherein a purity of the [Sn(OC(CH₃)₃)₂]₂ is at least 99.9%.

29. A composition comprising:
a stannous alkoxide of the formula:
[Sn(OR)₂]ₙ,
where:
R is independently at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 1, 2, 3, or 4.

30. The composition of claim 29, wherein a purity of the stannous alkoxide is at least 99.9%.

31. The composition of claim 29, wherein the stannous alkoxide is [Sn(OC(CH₃)₃)₂]₂.

32. The composition of claim 31, wherein a purity of the [Sn(OC(CH₃)₃)₂]₂ is at least 99.9%.
